(19) United States
(12) Patent Application Publication
(10) Pub. No.: US 2024/0343207 A1
(43) Pub. Date: Oct. 17, 2024

(54) FASTENING ARRANGEMENT

(71) Applicant: Ford Global Technologies, LLC, Dearborn, MI (US)

(72) Inventor: Patrick Mosses, Kempen (DE)

(73) Assignee: Ford Global Technologies, LLC, Dearborn, MI (US)

(21) Appl. No.: 18/632,544

(22) Filed: Apr. 11, 2024

(30) Foreign Application Priority Data
Apr. 12, 2023 (DE) 102023109217.0

(51) Int. Cl. B60R 13/02

(52) U.S. Cl. CPC B60R 13/0206

(57) ABSTRACT

A fastening arrangement for fastening a secondary part defining a top side to a primary part includes a support element with a contact hole portion for underside contact on the primary part and a contact passage hole that extends in a displacement direction. An adjustment hole portion has an adjustment passage hole and is arranged in a spacing position at a distance from the contact hole portion. The contact hole portion and the adjustment hole portion are connected together via a pivot portion at the end relative to the displacement direction. A shank of a bolt can be guided through the passage holes and the adjustment hole portion is adjustable into a support position on the contact hole portion by a pivot movement of the pivot portion. The bolt can be displaced along the contact passage hole in the displacement direction by a form fit with the adjustment hole portion.

### CROSS-REFERENCE TO RELATED APPLICATION

This application claims priority to and the benefit of German Patent Application No. 102023109217.0, filed on Apr. 12, 2023. The disclosure of the above application is incorporated herein by reference.

### FIELD

The present disclosure relates to a fastening arrangement.

### BACKGROUND

The statements in this section merely provide background information related to the present disclosure and may not constitute prior art.

The mounting of components of a motor vehicle, e.g., components of the bodywork or trim, calls for a reproducible arrangement of these components relative to one another. With respect to precision, firstly functional criteria may be considered and secondly aesthetic criteria in the case of visible components. Too large or greatly varying a gap size on trim components or similar is unfavourable, even if this entails no functional disadvantages. Therefore, the relative location of components should be as precise as possible, with regard to both production of the individual components and also the subsequent mounting process. Every location system retains a degree of play since all parts of connected components or assemblies have some tolerance, which in the case of complex assemblies can total a substantial amount. A reduction in the permitted tolerance could, however, firstly drive prices upward. Secondly, unless the corresponding precision is provided for all components involved (which is perhaps impossible), a reduction in tolerance may inhibit assembly since the components are too tightly dimensioned.

This leads to a degree of inaccuracy in the finished assembly since the definitive position varies because of the available play. Gap sizes may be irregular, seals may deform unevenly etc. In addition, when secured by bolts, these may transmit a torque to the components when tightened. Due to this, components mounted mirror-symmetrically on the right and left may react differently to one another, since the bolts are tightened with a clockwise rotation. As a result of this torque, the visible gap sizes in the assemblies are different on the right and left.

The present disclosure addresses these and other issues with typical fastening arrangements.

### SUMMARY

This section provides a general summary of the disclosure and is not a comprehensive disclosure of its full scope or all of its features.

The disclosure provides a reproducible positioning of two components connected by bolts.

The present disclosure provides a fastening arrangement.

The features and measures listed individually in the following description may be combined with one another in any technical suitable fashion and indicate further forms of the disclosure. The description characterises and specifies the disclosure further, in particular in connection with the figures.

The disclosure provides a fastening arrangement for fastening a secondary part defining a top side to a primary part. The primary and secondary parts may be vehicle parts, for example parts of a motor vehicle such as a car or truck. The primary part may be larger than the secondary part. The primary part may belong to a pre-mounted assembly which, as a whole, is larger than the secondary part. Both the primary part and the secondary part may include a plurality of interconnected components. The actual arrangement of the two parts when used may differ. Thus, these may be arranged above or next to one another with respect to the direction of gravitational force. Here and below however, the side on which the secondary part is arranged is defined as the top side. This means that the secondary part is arranged on the primary part. Conversely, the primary part is arranged below the secondary part, i.e., on its underside.

The fastening element has a support element, wherein the fastening element may, in some cases, include only the support element. The term “support element” is based on the term “support washer” and indicates that the support element is used similarly in certain aspects. Otherwise, the term should not be interpreted restrictively. The support element has a contact hole portion for underside contact on the primary part and with a contact passage hole extending in a displacement direction. The contact hole portion is provided to lie against the underside of the primary part. This, together with the support element, in an assembled state, is arranged on the side of the primary part opposite the secondary part, i.e., on the underside. Accordingly, the shape of the support element may be adapted to the shape of the primary part. In one form, the support element is formed at least mainly flat. The contact hole portion has a contact passage hole. This passage hole runs from top to bottom, i.e., in the vertical direction, through the contact hole portion. The contact passage hole may not have a round cross-section but is configured as a slot, wherein the passage hole extends in a displacement direction. The displacement direction is thus defined by the geometry of the contact passage hole. The displacement direction runs at an angle (i.e., non-parallel) to the vertical and may in some cases run horizontally.

The support element furthermore has an adjustment hole portion which has an adjustment passage hole and is arranged in a spacing position at a distance from the contact hole portion. The adjustment hole portion may also be formed flat, but other designs are also conceivable. The adjustment hole portion has an adjustment passage hole. This may have a circular cross-section. The spacing position may, as a whole, be regarded as a position of the adjustment hole portion or as a position of the support element. In this spacing position, the adjustment hole portion lies at a distance from the contact hole portion. In one form, the adjustment hole portion is arranged at a distance below the contact hole portion. The term “adjustment hole portion” indicates that this portion can be adjusted into a further position, as will be explained below.

The contact hole portion and the adjustment hole portion are connected together via a pivot portion. The pivot portion thus connects the two hole portions, i.e., each hole portion is connected to the pivot portion. In one form, the connection may lie at the end relative to the displacement direction, i.e., at one end of the hole portion in the displacement direction. The pivot portion may also be formed flat. In one form the pivot portion runs obliquely to the contact hole portion, i.e. not perpendicularly (at an angle of 90°). In particular, the pivot portion may run at an angle between 20° and 80°, or between 100° and 160° to the contact hole portion. In one variation, the pivot portion may slope in the displacement direction.

A shank of a bolt can be guided through the passage holes. In other words, the contact passage hole and the adjustment passage hole are arranged at least partially aligned so that the shank can be guided through both. Evidently, the dimensions of the shank, in particular the diameter, must be adapted to the dimensions of the support element. The bolt may itself be regarded as part of the fastening arrangement.

The adjustment hole portion is adjustable into a support position on the contact hole portion by a pivot movement of the pivot portion, wherein the bolt can be displaced along the contact passage hole in the displacement direction by a form fit with the adjustment hole portion. In the support position, the adjustment hole portion lies at least partly on the contact hole portion, i.e., the distance is reduced in comparison with the spacing position. The adjustment process, via which the adjustment hole portion is transferred into the support position, is achieved by a pivot movement of the pivot portion. The pivot portion pivots relative to the contact hole portion. Also, the adjustment hole portion pivots relative to the pivot portion. The pivot portion and/or the adjustment hole portion may also be deformed to a negligible extent. Thus, the part of the adjustment hole portion next to the pivot portion rotates around the region in which the pivot portion is connected to the contact hole portion. Due to the rotational movement, the approach of the adjustment hole portion to the contact hole portion is coupled to a lateral displacement. As will be explained below, in some cases the pivot movement may partially be superposed with a further movement and/or deformation, so that there is no continuous arcuate movement. To this extent, the phrase “by a pivot movement of the pivot portion” does not mean that the adjustment takes place exclusively by the pivot movement. As a whole however, there is a partial displacement in the above-mentioned displacement direction because of the pivot movement. This applies to the adjustment hole portion with the adjustment passage hole and to the bolt if this is received by form fit in the adjustment passage hole. Since the shank of the bolt is guided not only through the adjustment passage hole but also through the contact passage hole, the displacement of the shank of the bolt is partially determined by the course of the contact passage hole. Due to the hole being elongated in the displacement direction, the bolt can be displaced in this direction. If the bolt engages with the secondary part-the secondary part is also displaced in the displacement direction. The displacement is controlled and is predefined by the orientation of the support element and not. by the geometry of the primary element, the secondary element or the rotation direction of the bolt. In practice therefore, it is possible to displace the secondary part in the direction of an adjacent component such that a gap initially present is closed (or at least significantly reduced) or a seal is compressed. The fastening arrangement according to the disclosure finally allows a gap-free and/or gapless mounting, even when various components involved have a comparatively large tolerance.

The support element per se may be regarded as a fastening arrangement insofar as it serves for fastening the secondary part to the primary part. In addition, further elements may be regarded as part of the fastening arrangement. According to one form, the fastening arrangement has the primary part with a primary part passage hole which is larger at least in the displacement direction than the adjustment passage hole; the bolt which is arranged with a head below the adjustment hole portion and is guided with the shank through the adjustment passage hole, the contact passage hole and the primary part passage hole; and the secondary part with which the bolt at least indirectly forms a form fit. The contact hole portion lies on the primary part, wherein the contact hole portion is twist-secure. In other words, the contact hole portion cannot be rotated about the axis of the bolt, so an orientation of the contact hole portion and contact passage hole remains the same when the bolt is turned. Thus, the displacement direction relative to the primary part is retained. The primary part passage hole is larger, at least in the displacement direction, than the adjustment passage hole. Thus, the shank of the bolt can be received in the adjustment passage hole with little play, while the shank of the bolt is displaceable in the displacement direction in the primary part passage hole. This corresponds to the displacement within the contact passage hole. In one form, the extent of the primary part passage hole in the displacement direction corresponds at least to that of the contact passage hole. Whereas however the contact passage hole is configured as a slot, the primary part passage hole may e.g. have a circular cross-section. The bolt is arranged with the head below the adjustment hole portion. The head is dimensioned larger than the adjustment passage hole so the head cannot pass through the latter, but forms a form fit with the edge region. The shank of the bolt is guided through the adjustment passage hole, the contact passage hole and the primary part passage hole. Accordingly, these passage holes are at least partially aligned. The secondary part, which is arranged on the top side of the primary part lying opposite the support element, at least indirectly forms a form fit with the bolt, or more precisely the shank of the bolt. An indirect form fit may result for example if the shank is guided through a fourth passage hole in the secondary part and screwed to a nut, which in turn forms a form fit with the secondary part.

As has already been explained, by adjustment of the adjustment hole portion from the spacing position into the support position, the primary part can be displaced in the displacement direction. This may not mean, depending on the form, that adjustment from the support position into the spacing position, via which the primary part is moved in the opposite direction, is possible.

One form provides that in the transitional region from a pivot portion to a hole portion, a hinge region is formed which extends transversely to the displacement direction and is flexible to allow the pivot movement. The hinge region may in some cases not be clearly delimited from the hole portion and the pivot portion. However, the hinge portion is formed flexible while the adjacent portions are comparatively stiff. In one form, during the pivot movement, the hinge region is (plastically and/or elastically) bendable while the adjacent regions are comparatively bend-resistant. The hinge region extends transversely to the displacement direction, wherein the hinge region, in one form, runs parallel to a transverse direction running perpendicularly to the displacement direction.

According to one form, at least one region of the support element, such as a hinge region, is deformable such that by superposition of deformation of the at least one region with the pivot movement of the pivot portion, the adjustment hole portion is adjustable in the displacement direction into the support position when an at least indirect form fit between the bolt and the primary part inhibits a further displacement of the bolt in the displacement direction. In some cases, adjustment into the support position cannot be achieved completely by the pivot movement. During a pivot movement, the displacement of the bolt may be stopped because the bolt hits against the edge of the primary part passage hole, or because the secondary part engaging with the bolt hits against the primary part (e.g., because a gap is already closed). In this case, a simple pivot movement is no longer sufficient to reach the support position since the bolt cannot move further in the displacement direction and the adjustment hole portion forms a form fit with the bolt. In this case, at least one portion of the support element deforms, and by superposition of the deformation with the pivot movement, the adjustment hole portion may be adjusted perpendicularly to the displacement direction into the support position. The deformation may be a bending and/or folding of the portion. Normally, at least one hinge portion is deformable in the described fashion. The deformation of the hinge portion may lead to a pivot portion being displaced parallel (or anti-parallel) to the displacement direction relative to an adjacent hole portion. For example, the pivot portion may draw nearer to the hole portion, wherein the interposed hinge region is unfolded.

At least one pivot portion, and, in one form, at least one hole portion, has at least one side flange arranged laterally transversely to the displacement direction. This flange serves to mechanically stabilize the respective portion and inhibit, or at least reduce, a bending thereof. The flange is arranged laterally relative to the above-mentioned transverse direction running transversely to the displacement direction. The flange may extend at least partly in the displacement direction and also run at least in portions parallel to the displacement direction. Advantageously, side flanges are provided on both sides of the portion. To inhibit an interference of the side flanges with the primary part, these extend downward starting from the respective portion, i.e., away from the primary part. In order to inhibit the adjustment hole portion from intersecting with the side flanges of the contact hole portion in the support position, the adjustment hole portion may be configured narrower than the contact hole portion transversely to the displacement direction. In this way, the adjustment hole portion (in some cases including its assigned side flange) may lie between the side flanges of the contact hole portion.

In order to be able to perform the adjustment into the support position with increased control and guide the bolt in the displacement direction, the movement of the pivot portion takes place in a (vertical) plane running parallel to the displacement direction. For this, a hinge region, formed in the transitional region from a pivot portion to a hole portion, defines a pivot axis running transversely to the displacement direction. The hinge region in any case is configured such that the hinge region allows a pivot movement of the adjacent portions, i.e., the pivot portion and the hole portion. A pivot axis is defined so that the portions can pivot about this axis but not (or only with difficulty) about another axis. The pivot axis runs perpendicularly to the proposed pivot plane of the pivot portion and hence transversely to the displacement direction, i.e., in the transverse direction.

The hole portions and the at least one pivot portion are formed integrally from a planar material. In other words, they may be made from a single piece which can be obtained from a larger material piece by one or more cutting processes. Apart from cutting (e.g., by punching), usually shaping is desired which may take place in one or more steps. The term “planar” means that the material has a thickness which is significantly smaller than its other dimensions. The planar material may be a plate, i.e., a metal plate. Suitable metals are, for example, ferrous alloys such as steel. In addition, plastics or composite substances may also be used. In this form, the material piece from which the portions are formed can deform during the adjustment process without tearing or breaking. The material must therefore have adequate flexibility. The deformation may be at least partly elastic and/or plastic. In particular, local bending of the material may take place, e.g., in an above-mentioned hinge portion.

In one form, the bolt engages e.g., with a nut which in turn forms a form fit with the secondary part. In one variation, the secondary part has a secondary part hole with an internal thread into which the bolt is screwed. In this way, a direct form and force fit is created between the bolt and the secondary part. The guidance exerted by the lower portion on the bolt is transmitted directly to the secondary part. Also, the number of parts is reduced if the nut is omitted. In this form, the internal thread may be cut by the bolt during screwing, e.g., if the corresponding portion of the secondary part with the secondary part hole is made of plastic.

The reliability of the adjustment process and the guidance of the bolt may be suitably configured if, instead of a single pivot portion, two pivot portions are provided. In a corresponding form, the fastening arrangement has a pivot portion arranged at the end of the adjustment hole portion on each side relative to the displacement direction. Thus, relative to the displacement direction, a first pivot portion is provided at one end and a second pivot portion at the other end. At least one of the pivot portions connects the adjustment hole portion to the contact hole portion. The second pivot portion may in some cases not be directly connected to the contact hole portion but be secured relative to the contact hole portion by a further element (e.g., a portion of the primary part) such that the second pivot portion can also pivot relative to the contact hole portion. The lengths of the two pivot portions may be identical or differ by e.g., maximum 20% or maximum 10%. Also, the lengths of the hole portions may be the same or differ by e.g. maximum 20% or maximum 10%. This gives a generally parallelogram-like form of the support element, wherein the pivot portions slope at least approximately equally relative to the contact hole portion. Both the hole portions and the pivot portions may remain mutually parallel or approximately parallel during the pivot process.

As has already been explained, displacements of the contact hole portion relative to the primary part, at least in the displacement direction, should be reduced or inhibited. This may in principle be achieved by a force-fit and/or a substance-bonded connection. In one form, the support element forms a form fit with the primary part in the displacement direction. In other words, the support element and the primary part engage with one another by form fit so that the support element, and in one variation the contact hole portion, can rest on the primary part during the pivot movement and associated displacement of the bolt and secondary part. The form fit may simultaneously serve as a positioning aid for the support element during assembly.

One form provides that the support element has at least one tab portion which engages by form fit in a retaining hole in the primary part. The retaining hole may be configured as a blind hole which is open towards the bottom. The retaining hole may also be formed as a passage hole. The tab portion engages by form fit in the retaining hole or, in the case of a passage hole, the tab portion may pass through the latter. The tab portion may be connected to a hole portion or a pivot portion. In one form the tab portion may be arranged at the end of the hole portion or pivot portion relative to the displacement direction. In one variation the tab portion is formed integrally with the other portions, and in one form from the above-mentioned planar material. Here, in one variation the tab portion is angled relative to the adjacent portion. In one form the support element may include two tab portions, e.g. one on a pivot portion and one on a hole portion. The form fit in the retaining hole secures both the tab portions and the (pivot or passage) portions connected therewith relative to one another. In other words, not only is the position of the support element relative to the primary part secured, but also the stability of the support element is increased.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

Further advantageous details and effects of the disclosure are explained below with reference to an exemplary form illustrated in the figures. In the drawings:

FIG. 1 shows a perspective view of a first support element of the fastening arrangement according to the present disclosure;

FIG. 2 shows a cross-sectional view of a fastening arrangement according to the present disclosure with the support element from FIG. 1 in a first state;

FIG. 3 shows a cross-sectional view of a part of the fastening arrangement from FIG. 2 in a second state;

FIG. 4 shows a cross-sectional view of part of the fastening arrangement of FIG. 2 taken along line IV-IV shown in FIG. 3;

FIG. 5 shows a cross-sectional view of a part of the fastening arrangement from FIG. 2 in a third state;

FIG. 6 shows a cross-sectional view of a part of the fastening arrangement from FIG. 2 in a fourth state;

FIG. 7 shows a cross-sectional view of the fastening arrangement from FIG. 2 in the fourth state;

FIG. 8 shows a cross-sectional view of a part of the fastening arrangement from FIG. 2 in a fifth state;

FIG. 9 shows a cross-sectional view of a part of a fastening arrangement according to the present disclosure with a second support element in a first state;

FIG. 10 shows a cross-sectional view of a part of the fastening arrangement from FIG. 7 in a second state; and

FIG. 11 shows a cross-sectional view of a part of the fastening arrangement from FIG. 7 in a second state.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the various figures, the same parts always carry the same reference signs so these are usually only described once.

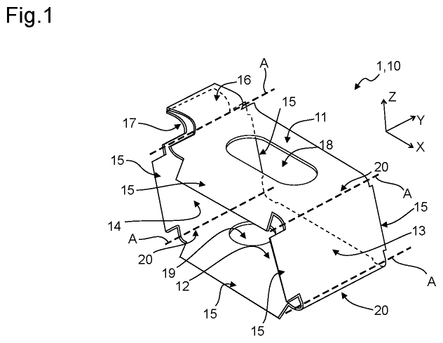

FIG. 1 shows a first form of a support element 10 of a fastening arrangement 1 according to the disclosure. The support element 10 is made integrally from a steel sheet, wherein the initially flat form of the support element 10 is cut or punched from a larger piece, after which the shape shown in FIG. 1 is produced by a plurality of bending processes. The support element 10 has a flat contact hole portion 11 in which a contact passage hole 18 is formed. This is configured as a slot and is elongated in a displacement direction X, i.e., has a greater dimension in this direction than in a transverse direction Y perpendicular thereto. An adjustment hole portion 12 runs parallel to the contact hole portion 11 and has an adjustment passage hole 19, which has a circular cross-section and is approximately the same size as the contact passage hole 18 in the transverse direction Y. The adjustment hole portion 12, in a spacing position illustrated in FIGS. 1 to 4, is at a distance from the contact hole portion 11 with respect to a vertical axis Z.

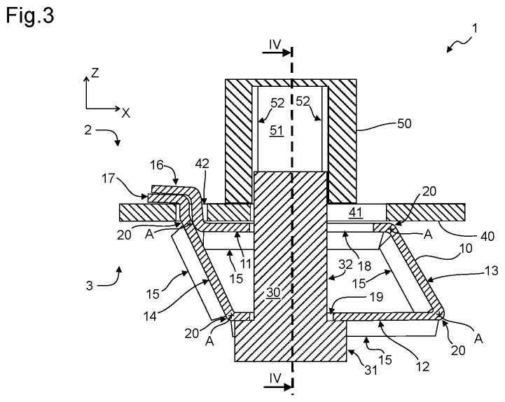

As evident from the illustration in FIG. 3, which shows the support element 10 in the same state as in FIG. 1, the passage holes 18, 19 align in the vertical direction Z. The contact hole portion 11 and the adjustment hole portion 12 are connected by a first pivot portion 13 at the end relative to the displacement direction X. At an opposite end relative to the displacement direction X, the adjustment hole portion 12 is connected to a second pivot portion 14. Tab portions 16, 17 adjoin the contact hole portions 11 and the second pivot portion 14. Laterally on both sides relative to the transverse direction Y, both the hole portions 11, 12 and also the pivot portions 13, 14 have side flanges 15 which are formed by angled regions of the steel sheet. As evident from FIG. 1, the side flanges 15 do not extend throughout. Rather, at the transition (also referred to herein as a transition region) between a respective hole portion 11, 12 and an adjacent pivot portion 13, 14, hinge regions 20 are formed which have no side flange 15. In such a hinge region 20, the steel sheet can bend substantially more easily about the transverse axis Y than at the hole portions 11, 12 or pivot portions 13, 14. Accordingly, each hinge region 20 defines a pivot axis A about which the adjacent portions 11 to 14 are pivotable relative to one another. The length of the first pivot portion 13 corresponds approximately to the length of the second pivot portion 14, and the length of the contact hole portion 11 corresponds approximately to the length of the adjustment hole portion 12. In this example, the two pivot portions 13, 14 slope by around 25° relative to the vertical direction Z in the direction of the displacement direction, which corresponds to a slope of 65° or 115° relative to the contact hole portion 11. This gives a generally parallelogram-like shape of the support element 10. Other slopes are also possible and suitable within the scope of the disclosure.

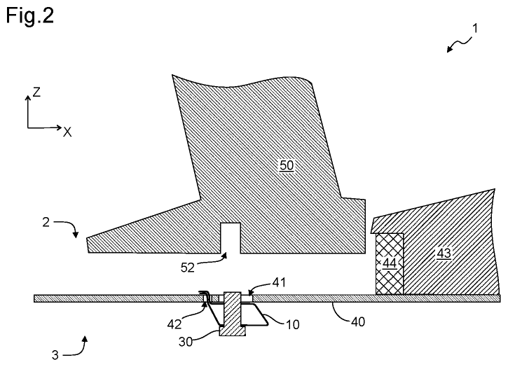

FIGS. 2 to 8 illustrate the use of the support element 10 as part of a fastening arrangement 1 for connecting a primary part 40 (in this case a door panel) to a secondary part 50 (in this case a door mirror). The connecting process provides for the secondary part 50 to come to rest on a seal 44 arranged on a trim piece 43, which in turn is connected to the primary part 40. FIG. 2 shows a state in which the contact hole portion 11 of the support element 10 lies on an underside 3 of the primary part 40, and the above-mentioned tab portions 16, 17 thereof engage in a retaining hole 42 of the primary part 40. A shank 32 of a bolt 30 passes through the adjustment passage hole 19, the contact passage hole 18 and a primary part passage hole 41, while a head 31 of the bolt 30 is retained by form fit on the underside of the adjustment hole portion 12. The primary part passage hole 41 has a circular cross-section, the diameter of which in this case corresponds approximately to the extent of the contact passage hole 18 in the displacement direction X. The secondary part 50 is not yet connected to the further elements and is still remote from a top side 2 of the primary part 40.

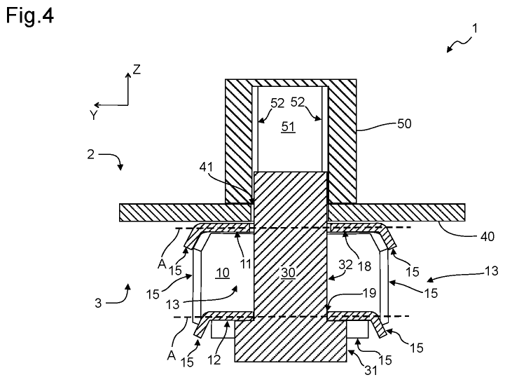

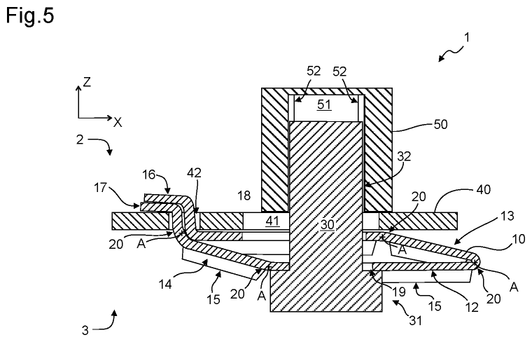

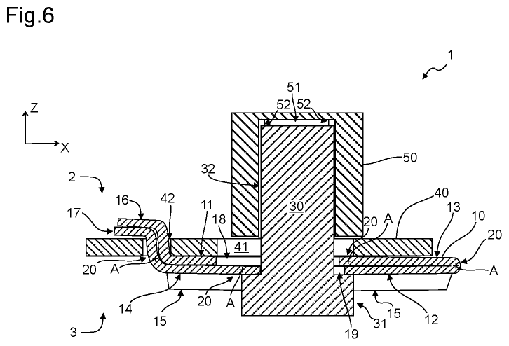

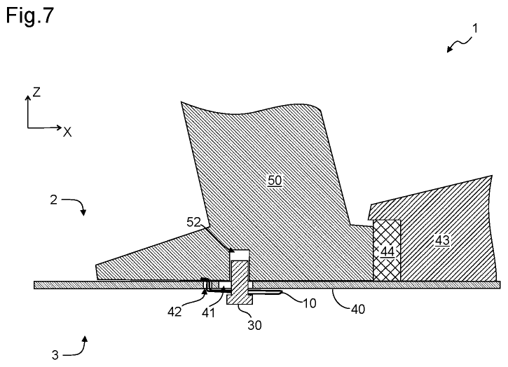

In FIGS. 3 and 4, which show the primary part 40 and secondary part 50 in simplified form, the shank 32 of the bolt 30 is screwed into a secondary part hole 51, which for this has an internal thread 52. The secondary part 50 now lies against a top side 2 of the primary part 40. If the bolt 30 is now tightened further, this leads to deformation of the support element 10. The adjustment hole portion 12 is drawn towards the contact hole portion 11 in the vertical direction Z. The result is a pivot movement of the pivot portions 13, 14 relative to the contact hole portion 11, which is associated with a pivot movement of the adjustment hole portion 12 relative to the pivot portions 13, 14. Each of the pivot movements take place about one of the above-mentioned pivot axes A, wherein a deformation of the hinge regions 20 takes place. A displacement of the contact hole portion 11 or second pivot portion 14 is inhibited because the tab portions 16, 17, as outlined above, engage in the retaining hole 42. During the described pivot movements, the support element 10 is compressed in the vertical direction Z, while at the same time the form fit between the bolt 30 and the adjustment passage hole 19 forces a displacement of the bolt 30 and the secondary part 50 connected therewith in the displacement direction X. FIG. 5 shows an intermediate position shortly before reaching the support position. When the support element 10, as shown in FIG. 6, is completely compressed corresponding to a support position, not only is a force fit created between the primary part 40 and the secondary part 50, but the secondary part 50 is also pressed against the seal 44 in the displacement direction X, as illustrated in FIG. 7.

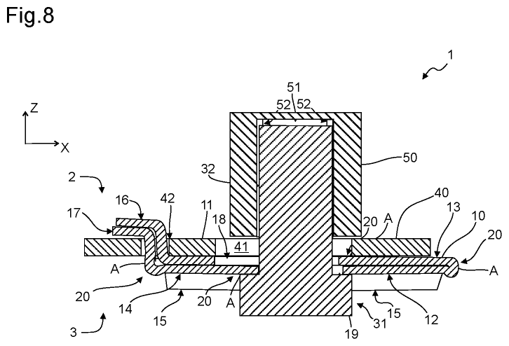

If, because of production tolerances, the secondary part 50, the trim piece 43 or the seal 44 have other dimensions, if they are positioned differently relative to one another or if, in an application case not illustrated here, no elastic seal is provided, it may be that FIG. 5 illustrates the final position of the bolt 30 and secondary part 50. In other words, a further displacement of the bolt 30 in the displacement direction X is no longer possible. In this case, the support position cannot be reached by a simple pivot movement of the pivot portions 13, 14. However, the hinge regions 20 are flexible and may be deformed between the respective adjacent pivot portion 13, 14 and hole portion 11, 12. A combination of this deformation with the pivot movement allows the adjustment hole portion 12 to be adjusted perpendicularly to the displacement direction X, or more precisely in the vertical direction Z. Finally, the state illustrated in FIG. 8 is achieved, in which two of the hinge regions 20 are curved or unfolded. The flexibility of the hinge regions 20 allows the support position to be reached reliably even if, in individual cases, the pivot portions 13, 14 are too long to allow a continuous pivot movement.

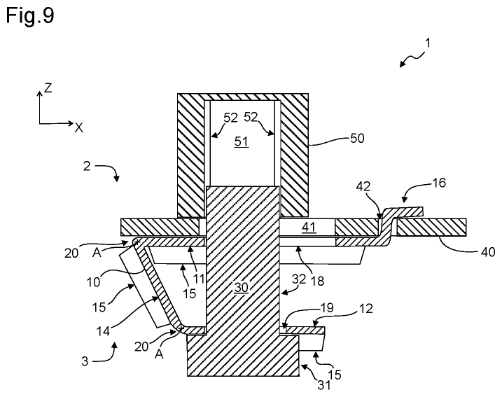

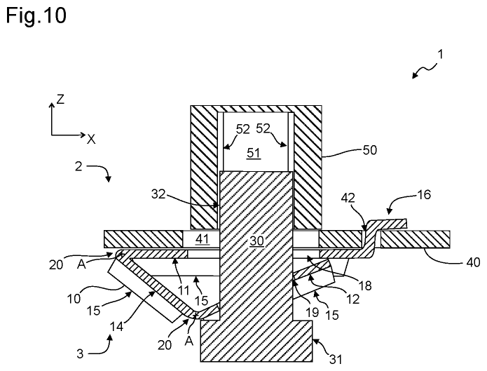

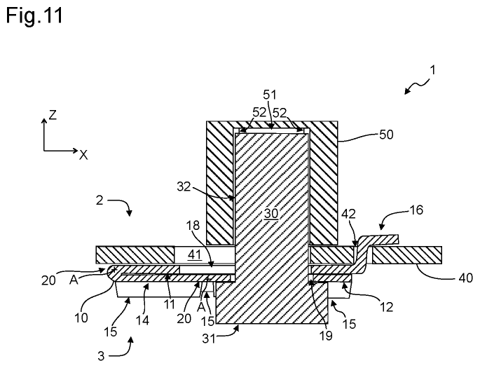

FIGS. 9 to 11 show a fastening arrangement 1 with a support element 10 according to a second form. The other elements do not differ from the illustration in FIGS. 2 to 8, except that in this case the retaining hole 42 is smaller and arranged on the opposite side of the primary part passage hole 41 relative to the displacement direction X. In this case, the support element 10 is designed more simply in that it has only one pivot portion 14 which connects the contact hole portion 11 to the adjustment hole portion 12. In the spacing position shown in FIG. 9, the hole portions 11, 12 are arranged parallel to one another, but in this case the adjustment hole portion 12 is significantly shorter than the contact hole portion 11. If the bolt 30 is tightened further, the pivot portion 14 pivots relative to the contact hole portion 11. In this case however, only a slight pivot movement of the adjustment hole portion 12 relative to the pivot portion 14 occurs. The pivot portions 14 and the adjustment hole portion 12 can also retain their relative positions until the adjustment hole portion 12 finally touches the contact hole portion 11, as shown in FIG. 10. In this case too, the bolt 30 is displaced in the displacement direction X, wherein the bolt 30 stands obliquely relative to the adjustment hole portion 12. To inhibit a tilting of the bolt 30 in the adjustment passage hole 19, the dimensions thereof must be selected sufficiently large. If, in the state shown in FIG. 10, the bolt 30 is screwed in further, this can lead to a pivoting not only of the pivot portion 14 relative to the contact hole portion 11, but also of the adjustment hole portion 12 relative to the pivot portion 14. Finally, both the pivot portion 14 and the adjustment hole portion 12 are arranged directly adjacent to the contact hole portion 11 on the underside, as shown in FIG. 11.

The support element 10 shown in FIGS. 9 to 11 is less complicated in design and saves material, but the guidance of the bolt 30 and secondary element 50 is more secure in the form shown in FIGS. 1 to 8 because of the two parallel pivot portions 13, 14.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A fastening arrangement for fastening a secondary part defining a top side to a primary part, the fastening arrangement comprising:
a support element, the support element including:
a contact hole portion configured to contact an underside of the primary part;
a contact passage hole extending in a displacement direction; and
an adjustment hole portion that includes an adjustment passage hole and is arranged in a spacing position at a distance from the contact hole portion, wherein the contact hole portion and the adjustment hole portion are connected together via at least one pivot portion at an end relative to the displacement direction, wherein the contact passage hole is configured to receive a shank of a bolt, wherein the adjustment hole portion is adjustable into a support position on the contact hole portion by a pivot movement of the at least one pivot portion, and wherein the bolt can be displaced along the contact passage hole in the displacement direction by a form fit with the adjustment hole portion.

2. The fastening arrangement according to claim 1, wherein the primary part includes a primary part passage hole which is larger, at least in the displacement direction, than the adjustment passage hole; wherein the bolt, which is arranged with a head below the adjustment hole portion, is guided with the shank through the adjustment passage hole, the contact passage hole and the primary part passage hole; and wherein the secondary part and at least the bolt indirectly form a form fit.

3. The fastening arrangement according to claim 1, further comprising a transitional region from the at least one pivot portion to at least one of the contact hole portion and the adjustment hole portion, wherein the transitional region forms a hinge region that extends transversely to the displacement direction and is flexible to allow the pivot movement.

4. The fastening arrangement according to claim 3, wherein the hinge region of the support element is deformable such that by superposition of a deformation of the hinge region with the pivot movement of the at least one pivot portion, the adjustment hole portion is adjustable in the displacement direction into the support position when an at least an indirect form fit between the bolt and the primary part inhibits a further displacement of the bolt in the displacement direction.

5. The fastening arrangement according to claim 1, wherein the at least one pivot portion and at least one of the contact hole portion and the adjustment hole portion, has at least one side flange arranged laterally transversely to the displacement direction.

6. The fastening arrangement according to claim 1, further comprising a hinge region formed in a transitional region from the at least one pivot portion to at least one of the contact hole portion and the adjustment hole portion that defines a pivot axis running transversely to the displacement direction.

7. The fastening arrangement according to claim 1, wherein the contact hole portion, the adjustment hole portion and the at least one pivot portion are formed integrally from a planar material.

8. The fastening arrangement according to claim 1, wherein the at least one pivot portion includes two pivot portions arranged at the end of the adjustment hole portion on each side relative to the displacement direction.

9. The fastening arrangement according to claim 1, wherein the support element, in the displacement direction, forms a form fit with the primary part.

10. The fastening arrangement according to claim 1, wherein the support element has at least one tab portion which engages by form fit in a retaining hole in the primary part.

11. A fastening arrangement for fastening a secondary part defining a top side to a primary part, the fastening arrangement comprising:
a support element, the support element includes:
a contact hole portion for underside contact on the primary part;
a contact passage hole extending in a displacement direction;
an adjustment hole portion that includes an adjustment passage hole and is arranged in a spacing position at a distance from the contact hole portion, wherein the contact hole portion and the adjustment hole portion are connected together via at least one pivot portion at an end relative to the displacement direction; and
a hinge region formed in a transitional region from the at least one pivot portion to at least one of the contact hole portion and the adjustment hole portion, the hinge region extends transversely to the displacement direction and defines a pivot axis running transversely to the displacement direction, the hinge region is flexible to allow a pivot movement,
wherein the contact passage hole is configured to receive a shank of a bolt,
wherein the adjustment hole portion is adjustable into a support position on the contact hole portion by the pivot movement of the at least one pivot portion,
wherein the bolt can be displaced along the contact passage hole in the displacement direction by a form fit with the adjustment hole portion, wherein the primary part includes a primary part passage hole which is larger, at least in the displacement direction, than the adjustment passage hole,
wherein the bolt, which is arranged with a head below the adjustment hole portion, is guided with the shank through the adjustment passage hole, the contact passage hole and the primary part passage hole; and
wherein the secondary part and at least the bolt indirectly form a form fit.

12. The fastening arrangement according to claim 11, wherein the hinge region of the support element is deformable such that by superposition of a deformation of the hinge region with the pivot movement of the at least one pivot portion, the adjustment hole portion is adjustable in the displacement direction into the support position when an at least indirect form fit between the bolt and the primary part inhibits a further displacement of the bolt in the displacement direction.

13. The fastening arrangement according to claim 11, wherein the at least one pivot portion and at least one of the contact hole portion and the adjustment hole portion, has at least one side flange arranged laterally transversely to the displacement direction.

14. The fastening arrangement according to claim 11, wherein the contact hole portion, the adjustment hole portion and the at least one pivot portion are formed integrally from a planar material.

15. The fastening arrangement according to claim 11, wherein the at least one pivot portion includes two pivot portions arranged at the end of the adjustment hole portion on each side relative to the displacement direction.

16. The fastening arrangement according to claim 11, wherein the support element, in the displacement direction, forms a form fit with the primary part.

17. The fastening arrangement according to claim 11, wherein the support element has at least one tab portion which engages by form fit in a retaining hole in the primary part.

18. A fastening arrangement for fastening a secondary part defining a top side to a primary part, the fastening arrangement comprising:
a support element, the support element includes:
a contact hole portion for underside contact on the primary part;
a contact passage hole extending in a displacement direction;
an adjustment hole portion that includes an adjustment passage hole and is arranged in a spacing position at a distance from the contact hole portion, wherein the contact hole portion and the adjustment hole portion are connected together via at least one pivot portion at an end relative to the displacement direction, and
a hinge region formed in a transitional region from the at least one pivot portion to at least one of the contact hole portion and the adjustment hole portion, the hinge region extends transversely to the displacement direction and defines a pivot axis running transversely to the displacement direction, the hinge region is flexible to allow a pivot movement;
wherein the contact passage hole is configured to receive a shank of a bolt,
wherein the adjustment hole portion is adjustable into a support position on the contact hole portion by the pivot movement of the at least one pivot portion,
wherein the bolt can be displaced along the contact passage hole in the displacement direction by a form fit with the adjustment hole portion,
wherein the primary part includes a primary part passage hole which is larger, at least in the displacement direction, than the adjustment passage hole,
wherein the bolt, which is arranged with a head below the adjustment hole portion, is guided with the shank through the adjustment passage hole, the contact passage hole and the primary part passage hole,
wherein the secondary part and at least the bolt indirectly form a form fit,
wherein the at least one pivot portion and at least one of the contact hole portion and the adjustment hole portion, has at least one side flange arranged laterally transversely to the displacement direction,
wherein the contact hole portion, the adjustment hole portion and the at least one pivot portion are formed integrally from a planar material,
wherein the support element has at least one tab portion which engages by form fit in a retaining hole in the primary part; and
wherein the support element, in the displacement direction, forms a form fit with the primary part.

19. The fastening arrangement according to claim 18, wherein the hinge region of the support element is deformable such that by superposition of a deformation of the hinge region with the pivot movement of the at least one pivot portion, the adjustment hole portion is adjustable in the displacement direction into the support position when an at least indirect form fit between the bolt and the primary part inhibits a further displacement of the bolt in the displacement direction.

20. The fastening arrangement according to claim 18, wherein the at least one pivot portion includes two pivot portions arranged at the end of the adjustment hole portion on each side relative to the displacement direction.
